(19) United States
(12) Patent Application Publication
(10) Pub. No.: US 2016/0368497 A1
(43) Pub. Date: Dec. 22, 2016

(54) VEHICLE SPEED CONTROL APPARATUS

(71) Applicant: TOYOTA JIDOSHA KABUSHIKI KAISHA, Toyota-shi (JP)

(72) Inventor: Yoshiaki IRIE, Chiryu-shi (JP)

(73) Assignee: TOYOTA JIDOSHA KABUSHIKI KAISHA, Toyota-shi (JP)

(21) Appl. No.: 15/167,322

(22) Filed: May 27, 2016

(30) Foreign Application Priority Data
Jun. 22, 2015 (JP) 2015-125067

(51) Int. Cl. B60W 30/18; B60W 10/18; B60W 10/06

(52) U.S. Cl. CPC B60W 30/18009; B60W 10/06; B60W 10/18; B60W 2550/142

(57) ABSTRACT

An engine is automatically stopped if a first condition including a condition that a braking operation is performed and a condition that a vehicle speed becomes less than or equal to a first speed is satisfied, and is automatically started if a second condition is satisfied, including a condition that, after the engine is automatically stopped, a braking stopping operation is performed. A braking force is automatically generated if it is determined that the vehicle is on an upslope, during a period from when the first condition is satisfied until starting the engine is completed. The first condition is satisfied as a result of the braking stopping operation before the vehicle is stopped after the engine is automatically stopped.

The present application is based on and claims the benefit of priority of Japanese Priority Application No. 2015-125067, filed on Jun. 22, 2015, the entire contents of which are hereby incorporated herein by reference.

### BACKGROUND

1. Technical Field

The present disclosure relates to a vehicle speed control apparatus mounted in a vehicle capable of carrying out idling stop control.

2. Description of the Related Art

In the related art, idling stop control is known where, if a predetermined engine stop condition is satisfied, a vehicle's engine is automatically stopped, and thereafter, if a predetermined engine start condition is satisfied, the engine is automatically restarted (for example, see Japanese Laid-Open Patent Application No. 2012-77650).

### SUMMARY

A vehicle control apparatus automatically stops an engine that is a drive power source of a vehicle if a predetermined engine stop condition, including a condition that a predetermined braking operation is performed and a condition that a vehicle speed that is detected becomes less than or equal to a predetermined first speed is satisfied, and automatically starts the engine if a predetermined engine start condition is satisfied, including a condition that, after the engine is automatically stopped, a predetermined braking stopping operation is performed, determines whether the vehicle is on an upslope, and causes the vehicle to automatically generate a braking force if at least one processor determines, based on a determination result that the vehicle is on the upslope, during a period of time from when the engine start condition is satisfied until the starting of the engine is completed, the engine start condition being satisfied as a result of the predetermined braking stopping operation being performed before the vehicle is stopped after the engine is automatically stopped.

Other objects, features and advantages will become more apparent from the following detailed description when read in conjunction with the accompanying drawings.

### BRIEF DESCRIPTION OF THE DRAWINGS

FIG. 1 is a configuration diagram illustrating one example of a vehicle;

FIG. 2 is a configuration diagram illustrating one example of a brake system included in the vehicle;

FIG. 3A is a block diagram illustrating one example of a vehicle control apparatus;

FIG. 3B illustrates one example of a hardware configuration of the vehicle speed control apparatus;

FIG. 4 is a flowchart conceptually illustrating one example of an engine automatic stop process in a deceleration idling stop control scheme carried out by a vehicle control ECU (an idling stop control part);

FIG. 5 is a flowchart conceptually illustrating one example of an engine automatic stop process in a stopping idling stop control scheme carried out by the vehicle control ECU;

FIG. 6 is a flowchart conceptually illustrating one example of an engine automatic start process carried out by the vehicle control ECU;

FIG. 7 is a flowchart conceptually illustrating one example of a flag initialization process carried out by the vehicle control ECU;

FIG. 8 is a flowchart conceptually illustrating one example of an upslope determination process carried out by the vehicle control ECU (an upload determination part);

FIG. 9 is a flowchart conceptually illustrating one example of a control process carried out by an engine ECU;

FIG. 10 is a flowchart conceptually illustrating one example of a control process carried out by a braking ECU;

FIG. 11 is a flowchart conceptually illustrating one example of a restart braking control scheme carried out by a vehicle control apparatus (a brake control part);

FIG. 12 is a timing chart illustrating one example of operations of the vehicle control apparatus;

FIG. 13 is a timing chart illustrating another example of operations of the vehicle control apparatus;

FIG. 14 illustrates one example of a map that illustrates relationships between a road gradient of a upslope and a vehicle speed at which a brake pressurization process is started; and

FIG. 15 illustrates one example of a map that illustrates relationships between a road gradient of an upslope and a brake pressurization rate.

### DETAILED DESCRIPTION OF EMBODIMENTS

For the purpose of convenience, the description of the above-mentioned related art will be continued first.

In an idling stop control scheme where an engine is stopped while a vehicle is decelerating before the vehicle is stopped (referred to as a “deceleration idling stop control scheme”), such a situation may occur where, at a time of the vehicle's deceleration, the engine's restart may occur due to the braking operation being stopped after the engine is stopped but before the vehicle is stopped.

In such a situation, no creep torque is generated in the vehicle during a period of time from when the braking operation is stopped and the engine begins starting to when the starting is completed. Therefore, if the vehicle is on an upslope, the vehicle's crawling down (a phenomenon that the vehicle moves in a descending direction opposite to the traveling direction) may occur depending on the vehicle speed at the time when the engine begins starting.

In consideration of such a situation, an object of the disclosure is to provide a vehicle control apparatus capable of preventing crawling down of a vehicle on an upslope when a braking operation is stopped and the engine is restarted before the vehicle is stopped after an engine is automatically stopped according to the idling stop control scheme.

Now, embodiments of the present invention will be described using drawings.

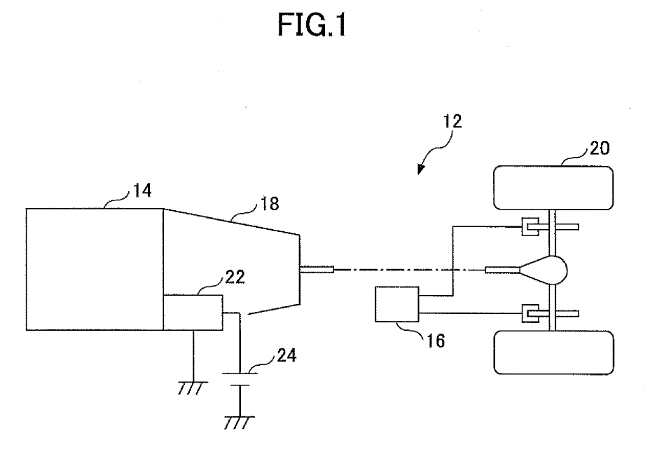

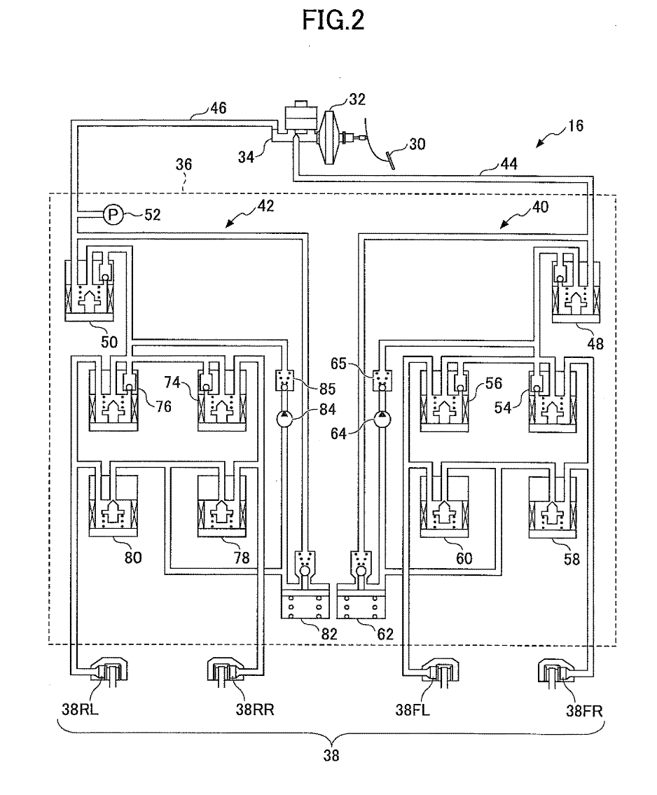

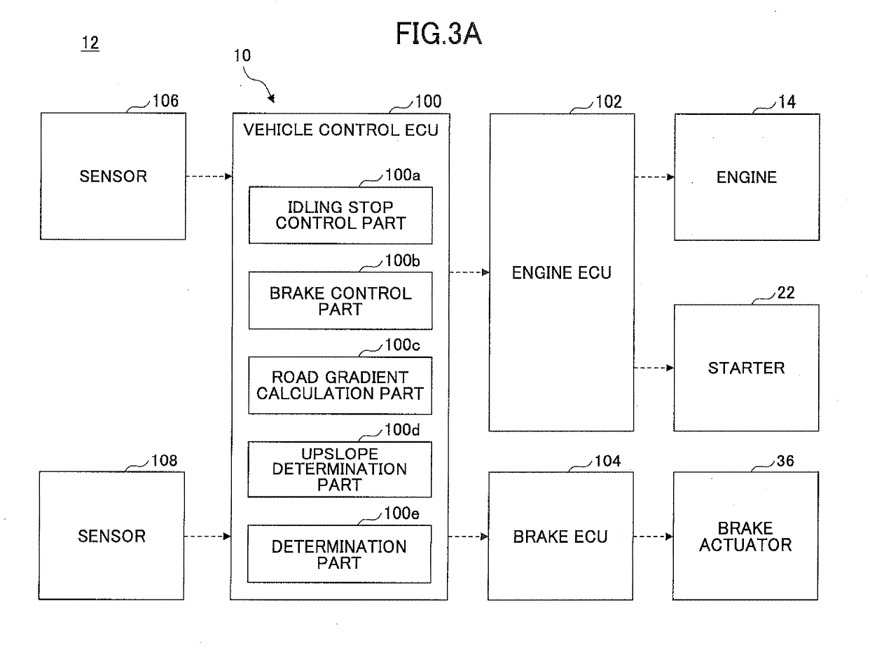

First, with reference to FIGS. 1 and 2, a configuration of a vehicle 12 that includes a vehicle control apparatus 10 (see FIG. 3A) will be described.

FIG. 1 is a configuration diagram illustrating one example of the vehicle 12. FIG. 2 is a configuration diagram illustrating one example of a brake system 16 included in the vehicle 12.

As shown in FIG. 1, the vehicle 12 includes an engine 14 and the brake system 16.

The engine 14 is an internal-combustion engine that generates power by combustion of gasoline, gas oil, or the like. The power of the engine 14 is transmitted to drive wheels 20 via a gearbox 18. The gearbox 18 is an automatic gearbox that has a torque converter capable of applying torque (creep torque) due to a creep phenomenon to the drive wheels 20.

The engine 14 has a starter 22 mounted thereto. The starter 22 starts the engine 14 through cranking using power supplied by a battery 24. The battery 24 is charged with power generated by an alternator driven and rotated by the engine 14.

The brake system 16 is a braking device that applies braking force to the vehicle 12. The brake system 16 is capable of applying the braking force corresponding to a braking operation amount (i.e., a depression amount of a brake pedal 30) given by the driver to the vehicle 12 (actually, the respective wheels thereof). The brake system 16 is also capable of applying the braking force to the vehicle 12 (actually, the respective wheels thereof) without regard to a braking operation (i.e., a depression operation on the brake pedal 30) performed by the driver. As shown in FIG. 2, the brake system 16 includes a brake pedal 30, a booster 32, a master cylinder 34, a brake actuator 36, and wheel cylinders 38FR, 38FL, 38RR and 38RL.

The booster 32 is connected to the brake pedal 30, and is connected to an intake manifold of the engine 14. The booster 32 amplifies the braking operation amount (the operation force) on the brake pedal 30 by using the pressure difference between the pressure (i.e., negative pressure) in the intake manifold and the atmospheric pressure, and outputs the amplified operation amount.

The master cylinder 34 converts the output of the booster 32 into a brake oil pressure (i.e., a master cylinder pressure, or a MC pressure). That is, the MC pressure is the brake oil pressure generated according to the braking operation amount (the operation force) on the brake pedal 30 by the driver. The master cylinder 34 is connected to an oil-hydraulic circuit in the brake actuator 36, and the MC pressure is supplied to the brake actuator 36.

The brake actuator 36 generates an output that drives the brake system 16, i.e., the brake oil pressures (i.e., wheel cylinder pressures) of the wheel cylinders 38FR, 38FL, 38RR and 38RL installed at the respective wheels. The wheel cylinders 38FR, 38FL, 38RR and 38RL include the wheel cylinder 38FR of the right front wheel, the wheel cylinder 38FL of left front wheels, the wheel cylinder 38RR of the right rear wheel, and the wheel cylinder 38RL of the left rear wheel.

The brake actuator 36 includes an oil-hydraulic circuit 40 corresponding to the front wheels and an oil-hydraulic circuit 42 corresponding to the rear wheels. The oil-hydraulic circuit 40 is connected to the master cylinder 34 via a working oil passage 44, and includes a regulating valve 48, holding valves 54 and 56, pressure reducing valves 58 and 60, a reservoir 62, a pump 64, and an accumulator 65. In the same way, the oil-hydraulic circuit 42 is connected to the master cylinder 34 via a working oil passage 46, and includes a regulating valve 50, holding valves 74 and 76, pressure reducing valves 78 and 80, a reservoir 82, a pump 84, and an accumulator 85. The oil-hydraulic circuits 40 and 42 have the same configurations and functions except that the output destinations of the wheel cylinder pressures are the front wheels (the right front wheel and the left front wheels) and the rear wheels (the right rear wheel and the left rear wheel), respectively. Therefore, below, description concerning the oil-hydraulic circuit 40 will be made, and description concerning the oil-hydraulic circuit 42 will be omitted. Note that the working oil passage 46 has a pressure sensor 52 that outputs a detection signal corresponding to the MC pressure.

The MC pressure supplied by the master cylinder 34 via the working oil passage 46 is output to the wheel cylinders 38FR and 38FL of the front wheels, normally via a normally-open-type regulating valve 48 and the holding valves 54 and 56. Thereby, the brake system 16 is capable of applying the braking force according to the driver's braking operation to the vehicle 12.

By closing the normally-open-type regulating valve 48 connected to the master cylinder 34 via the working oil passage 46, it is possible to maintain the brake oil pressure on the downstream side of the regulating valve 48 (on the wheel cylinders 38FR and 38FL side) to be the MC pressure immediately before closing the normally-open-type regulating valve 48. That is, as a result of the brake system 16 carrying out the operation, it is possible to automatically maintain the braking force of the vehicle 12 even if the driver's braking operation amount (the depression amount on the brake pedal 30) reduces to be less than a predetermined value.

By closing the normally-open-type holding valves 54 and 56 that are installed in working oil passages that connect between the regulating valve 48 and the respective wheel cylinders 38FR and 38FL, it is possible to maintain the wheel cylinder pressures of the respective wheel cylinders 38FR and 38FL separately.

By opening normally-close-type pressure reducing valves 58 and 60, the hydraulic oil is returned to the reservoir 62. Thus, it is possible to reduce the wheel cylinder pressures. In a state where the holding valves 54 and 56 are closed, it is possible to reduce the respective wheel cylinders 38FR and 38FL separately.

By driving the motor driven pump 64 in a state where the regulating valve 48 is closed to accumulate the hydraulic oil in the accumulator 65, it is possible to generate the wheel cylinder pressures (the pressurized brake oil pressures) greater than the MC pressure corresponding to the braking operation, and output them to the wheel cylinders 38FL and 38FR. A brake pressurization process described later is implemented as a result of the brake system 16 (the brake actuator 36) carrying out this operation.

The brake system 16 is controlled and driven by a brake ECU 104 described later.

With reference to FIGS. 3A and 3B, a configuration of the vehicle control apparatus 10 will be described.

FIG. 3A is a block diagram illustrating one example of a configuration of the vehicle control apparatus 10.

The vehicle control apparatus 10 includes a vehicle control Electronic Control Unit (ECU) 100, an engine ECU 102, and the brake ECU 104.

The vehicle control ECU 100 is an electronic control unit carrying out a main control process of the vehicle control apparatus 10. The vehicle control ECU 100 includes, as functional parts, an idling stop control part 100a, a brake control part 100b, a road gradient calculation part 100c, an upslope determination part 100d, and a determination part 100e.

The idling stop control part 100a carries out idling stop control (also called “start and stop control” or “eco-run control”). The idling stop control part 100a automatically stops the engine 14 if a predetermined the engine stop condition is satisfied, and thereafter, automatically restarts the engine 14 if a predetermined the engine start condition is satisfied. Actually, if the engine stop condition is satisfied, the idling stop control part 100a outputs an engine stop request to the engine ECU 102. If the engine start condition is satisfied, the idling stop control part 100a outputs an engine start request to the engine ECU 102.

The engine stop condition includes a condition that the driver performs a predetermined braking operation (i.e., a braking operation with a depression amount greater than or equal to a predetermined value on the brake pedal 30), and a condition that the vehicle speed becomes less than or equal to a predetermined starting vehicle speed (a first speed) V0. The engine stop condition can include, for example, a condition that an accelerator pedal is not operated (accelerator off), a condition that the negative pressure in the booster 32 is greater than or equal to a predetermined value, a condition that the road gradient G at a position on a road where the vehicle 12 is present is less than a predetermined threshold Gth, and so forth. The engine stop condition is satisfied if all these conditions are satisfied.

The engine start condition includes a condition that the driver performs a predetermined braking stopping operation (i.e., a braking operation performed by the driver with the depression amount on the brake pedal 30 less than or equal to a predetermined value). The engine start condition can include, for example, a condition that the accelerator pedal is operated (accelerator on), a condition that the negative pressure in the booster 32 is less than or equal to a predetermined value, a condition that the road gradient G at a position on a road where the vehicle 12 is present is greater than or equal to the predetermined threshold Gth, and so forth. The engine start condition is satisfied if any one of these conditions is satisfied.

The idling stop control scheme according to the embodiments can stop the engine 14 when a condition that the vehicle 12 has been stopped is satisfied (referred to as a “stopping idling stop control scheme”), in addition to the above-mentioned deceleration idling stop control scheme to stop the engine 14 even while the vehicle 12 is decelerating (i.e., even while the vehicle 12 is still traveling). The stopping idling stop control scheme and the deceleration idling stop control scheme have different engine stop conditions.

The engine stop condition for the stopping idling stop control scheme includes a condition that the vehicle 12 has been stopped (that is, the starting vehicle speed V0=0). The engine stop condition for the deceleration idling stop control scheme includes a condition that the vehicle speed V has become less than or equal to the starting vehicle speed V0 (for example, V0=6 km/h) through deceleration of the vehicle 12. The deceleration idling stop control scheme is such that even while the vehicle 12 is traveling, the engine 14 is stopped. Therefore, the engine stop condition for the deceleration idling stop control scheme includes a condition which is not included in the engine stop condition for the stopping idling stop control scheme, for example, a predetermined condition for ensuring safety travelling, such as a condition concerning the oil pressure in the gearbox 18. Therefore, if the predetermined condition for ensuring safety traveling is not satisfied, a stop of the engine 14 according to the “stopping idling stop control scheme” can occur prior to a stop of the engine 14 according to the deceleration idling stop control scheme.

The idling stop control part 100a is capable of carrying out both the stopping idling stop control scheme and the deceleration idling stop control scheme. Thus, the idling stop control part 100a automatically stops the engine 14 if the engine stop condition for the stopping idling stop control scheme is satisfied. Also, the idling stop control part 100a automatically stops the engine 14 if the engine stop condition for the deceleration idling stop control scheme is satisfied.

The idling stop control part 100a carries out idling stop control operations that include an operation of automatic stopping the engine 14 and an operation of automatic restarting the engine 14, by controlling various devices of the engine 14 (i.e., a fuel injection valve, an ignition device, and so forth), and the power supply to the starter 22 (with a starter relay), based on signals from various sensors, and/or signals from the engine ECU 102.

A hardware configuration of the vehicle control ECU 100 will now be described. FIG. 3B illustrates one example of the hardware configuration of the vehicle control ECU 100.

As shown in FIG. 3B, the vehicle control ECU 100 includes a Central Processing Unit (CPU) 201, a Random Access Memory (RAM) 202, a connection part 203, and a Read-Only Memory (ROM) 204. These elements of the vehicle speed control apparatus 40 are mutually connected by a bus 205.

The CPU 201 executes a program stored by the ROM 204 to implement the idling stop control part 100a, the brake control part 100b, the road gradient calculation part 100c, the upslope determination part 100d, and the determination part 100e, described above using FIG. 3A.

The RAM 202 is a main storage such as a Dynamic Random Access Memory (DRAM), a Static Random Access Memory (SRAM), or the like. The RAM 202 provides a work area where the program stored by the ROM 204 is held to be executed by the CPU 201. Also, the RAM 202 provides a storage area to temporarily store information generated as a result of the program stored by the ROM 204 being executed by the CPU 201.

The connection part 203 is an interface that is connected to various connection destinations such as the engine ECU 102, the brake ECU 104 and sensors 106 and 108, and sends and receives various information items among these various connection destinations.

The ROM 204 is a main storage such as an Erasable Programmable ROM (EPROM), an Electrically Erasable Programmable ROM (EEPROM), or the like, and stores the program to be executed by the CPU 201, and information used when the CPU 201 executes the program.

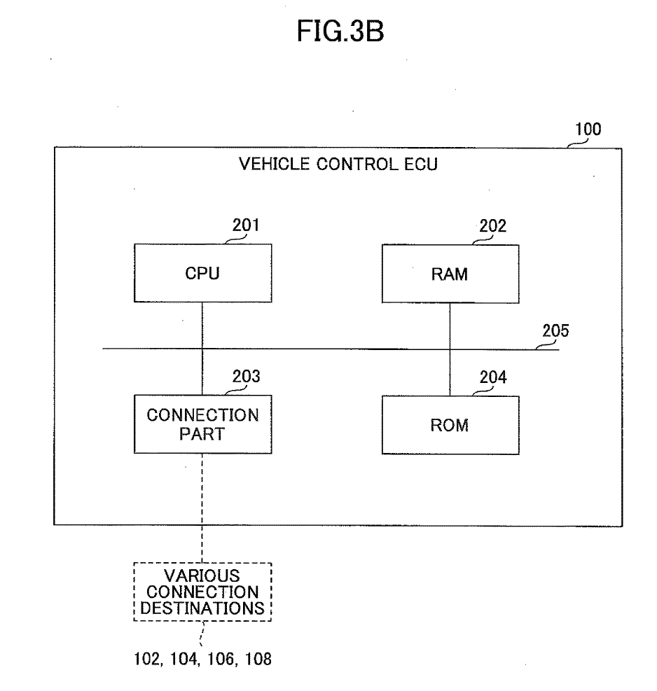

With reference to FIGS. 4 through 6, process flows of the idling stop control operations carried out by the idling stop control part 100a will be described.

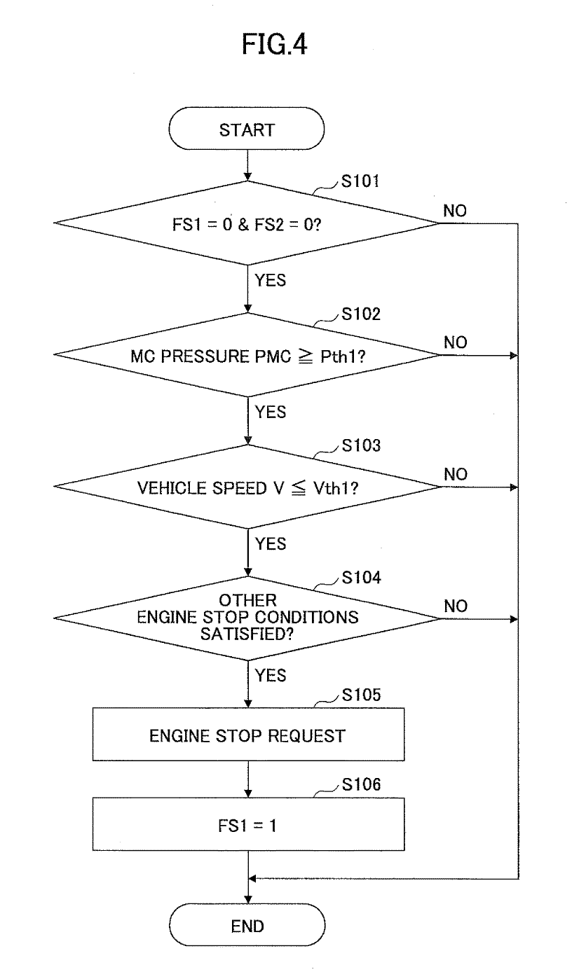

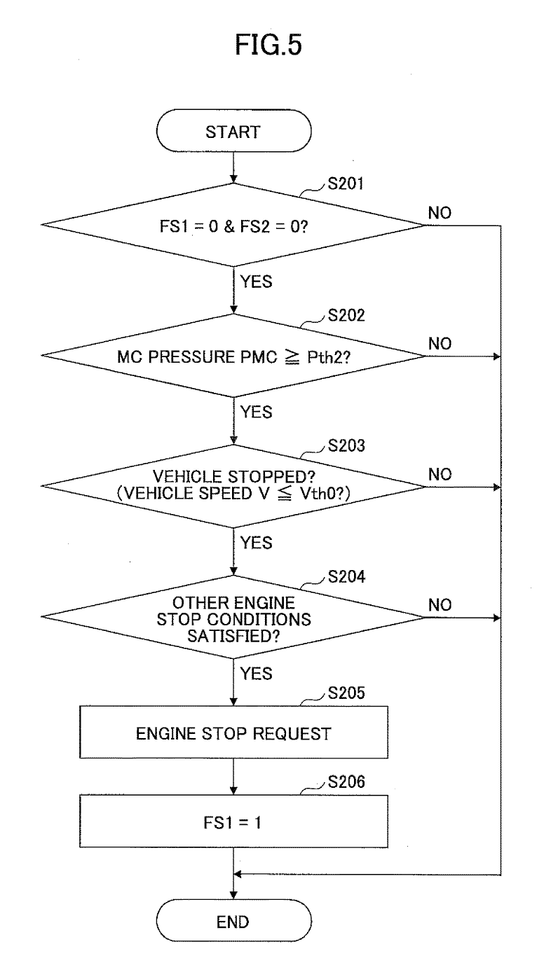

FIG. 4 is a flowchart conceptually illustrating one example of a process of automatically stopping the engine 14 (an engine automatic stop process) in the deceleration idling stop control scheme by the vehicle control ECU 100 (the idling stop control part 100a). FIG. 5 is a flowchart conceptually illustrating one example of a process of automatically stopping the engine 14 in the stopping idling stop control scheme by the vehicle control ECU 100 (the idling stop control part 100a). FIG. 6 is a flowchart conceptually illustrating one example of a process of automatically starting (restarting) the engine 14 (an engine automatic start process) by the vehicle control ECU 100 (the idling stop control part 100a). Each of these flows is repetitiously carried out every predetermined period of time (for example, every 50 ms) after the vehicle 12 is started (ignition on) until the vehicle 12 is stopped (ignition off).

Note that an engine stop flag FS1 indicates whether the engine 14 has been automatically stopped through an idling stop control operation. An engine start flag FS2 indicates whether the engine 14 has been started through an idling stop control operation. The engine stop flag FS1 and the engine start flag FS2 are set to have “0” as initial states when the vehicle 12 is started.

As shown in FIG. 4, in step S101, the idling stop control part 100a determines whether the engine stop flag FS1 and the engine start flag FS2 have “0”. If both the engine stop flag FS1 and the engine start flag FS2 have “0”, the idling stop control part 100a proceeds to step S102. Otherwise, the idling stop control part 100a ends the current process.

Through steps S102 through S104, it is determined whether the engine stop condition for the deceleration idling stop control scheme is satisfied.

In step S102, the idling stop control part 100a determines whether the driver is performing a predetermined braking operation, i.e., whether the MC pressure PMC detected by the pressure sensor 52 is greater than or equal to a predetermined threshold Pth1. If the MC pressure PMC is greater than or equal to the predetermined threshold Pth1, the idling stop control part 100a proceeds to step S103. If the MC pressure PMC is less than the predetermined threshold Pth1, the idling stop control part 100a ends the current process.

In step S103, the idling stop control part 100a determines whether the vehicle speed V detected by the vehicle speed sensor is less than or equal to a predetermined threshold Vth1 (>0) corresponding to the starting vehicle speed V0. If the vehicle speed V is less than or equal to the predetermined threshold Vth1, the idling stop control part 100a proceeds to step S104. If the vehicle speed V is greater than the predetermined threshold Vth1, the idling stop control part 100a ends the current process.

In step S104, the idling stop control part 100a determines whether the other conditions included in the engine stop condition are satisfied. If the other conditions are satisfied (YES), the idling stop control part 100a proceeds to step S105. If the other conditions are not satisfied (NO), the idling stop control part 100a ends the current process.

In step S105, the idling stop control part 100a outputs an engine stop request to the engine ECU 102.

Then, in step S106, the idling stop control part 100a sets “1” in the engine stop flag F51, and ends the current process.

As shown in FIG. 5, in step S201, the idling stop control part 100a determines whether the engine stop flag FS1 and the engine start flag FS2 have “0”. If both the engine stop flag FS1 and the engine start flag FS2 have “0”, the idling stop control part 100a proceeds to step S202. Otherwise, the idling stop control part 100a ends the current process.

Through steps S202 through S204, it is determined whether the engine stop condition for the stopping idling stop control scheme is satisfied.

In step S202, the idling stop control part 100a determines whether the driver is performing the predetermined braking operation, i.e., whether the MC pressure PMC is greater than or equal to a predetermined threshold Pth2. If the MC pressure PMC is greater than or equal to the predetermined threshold Pth2, the idling stop control part 100a proceeds to step S203. If the MC pressure PMC is less than the predetermined threshold Pth2, the idling stop control part 100a ends the current process.

The predetermined threshold Pth2 is greater than or equal to the predetermined threshold Pth1 for the engine start condition for the deceleration idling stop control scheme.

In step S203, the idling stop control part 100a determines whether the vehicle 12 has been stopped, i.e., whether the vehicle speed V detected by the vehicle speed sensor is less than or equal to a predetermined threshold Vth0 (i.e., a threshold at which it is possible to determine that the vehicle 12 has been stopped) corresponding to the starting vehicle speed V0. If the vehicle speed V is less than or equal to the predetermined threshold Vth0, the idling stop control part 100a proceeds to step S204. If the vehicle speed V is greater than the predetermined threshold Vth0, the idling stop control part 100a ends the current process.

In step S204, the idling stop control part 100a determines whether the other conditions included in the engine stop condition are satisfied. If the other conditions are satisfied, the idling stop control part 100a proceeds to step S205. If the other conditions are not satisfied, the idling stop control part 100a ends the current process.

In step S205, the idling stop control part 100a outputs an engine stop request to the engine ECU 102.

Then, in step S206, the idling stop control part 100a sets “1” in the engine stop flag FS1, and ends the current process.

As shown in FIG. 6, in step S301, the idling stop control part 100a determines whether the engine stop flag FS1 has “1”. If the engine stop flag FS1 has “1”, the idling stop control part 100a proceeds to step S302, If the engine stop flag FS1 does not have “1”, the idling stop control part 100a ends the current process.

In step S302, the idling stop control part 100a determines whether the driver has performed the predetermined braking stopping operation, i.e., whether the MC pressure PMC is less than or equal to a predetermined threshold Pth3 that is set to be less than or equal to the predetermined thresholds Pth1 and Pth2. If the MC pressure PMC is less than or equal to the predetermined threshold Pth3, the idling stop control part 100a proceeds to step S303. If the MC pressure PMC is greater than the predetermined threshold Pth3, the idling stop control part 100a proceeds to step S306.

In step S303, the idling stop control part 100a sets “2” in the engine start flag FS2.

In step S304, the idling stop control part 100a outputs an engine start request to the engine ECU 102.

Then, in step S305, the idling stop control part 100a sets “0” in the engine stop flag FS1, and ends the current process.

On the other hand, in step S306, the idling stop control part 100a determines whether the other conditions of the engine start condition are satisfied. If the other conditions are satisfied (YES), the idling stop control part 100a proceeds to step S307. If the other conditions are not satisfied either, the idling stop control part 100a ends the current process.

In step S307, the idling stop control part 100a sets “1” in the engine start flag FS2, and proceeds to step S304.

Thus, according to the idling stop control scheme, it is possible to automatically stop the engine 14 while the vehicle 12 is in the stopped state or the vehicle 12 is decelerating. Thus, it is possible to reduce the fuel consumption. According to the deceleration idling stop control scheme where the engine 14 is automatically stopped while the vehicle 12 is decelerating, it is possible to improve the fuel consumption reducing effect of the vehicle 12.

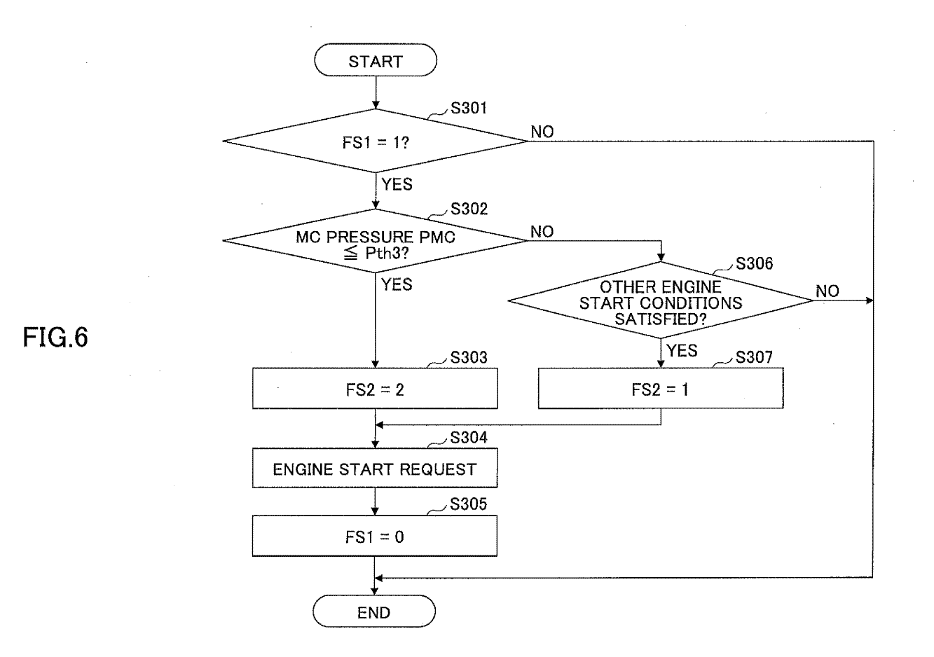

The engine start flag FS2 is returned to an initial state (i.e., FS2=“0”) after automatic starting of the engine 14 is completed, in the flow of FIG. 7. Below, this process flow will be described.

FIG. 7 is a flowchart that conceptually illustrates one example of a process of initializing the engine start flag FS2 by the vehicle control ECU 100 (the idling stop control part 100a) (a flag initialization process). This flow is repetitiously carried out every predetermined period of time (for example, every 50 ms) after the vehicle 12 is started until the vehicle 12 is stopped.

In step S401, the idling stop control part 100a determines whether the engine start flag FS2 has “0”. If the engine start flag FS2 does not have “0” (i.e., the engine start flag FS2 has “1” or “2”), the idling stop control part 100a proceeds to step S402. If the engine start flag FS2 has “0”, the idling stop control part 100a ends the current process.

In step S402, the idling stop control part 100a determines whether the idling stop control part 100a has received an engine start completion notification that will be described later from the engine ECU 102. If the idling stop control part 100a has received the engine start completion notification, the idling stop control part 100a proceeds to step S403. If the idling stop control part 100a has not received the engine start completion notification, the idling stop control part 100a ends the current process.

In step S403, the idling stop control part 100a sets “0” in the engine start flag FS2″, and ends the current process.

Returning to FIG. 3A, the brake control part 100b automatically applies braking force to the vehicle 12 when starting the engine 14 according to the idling stop control scheme depending on a predetermined condition (the restart braking control scheme). Actually, if the predetermined condition is satisfied, the brake control part 100b outputs a brake pressurization request to the brake ECU 104. Thereby, the brake ECU 104 controls the brake actuator 36 (i.e., the pumps 64 and 84, and the various valves 48, 50, 54, 56, 58, 60, 74, 76, 78, and 80) so that braking force can be applied to the respective wheels automatically. Also, after outputting the brake pressurization request, the brake control part 100b outputs a the brake pressurization stop request to the brake control part 100b if a predetermined condition is satisfied, in order to exit the state of automatically applying the braking force to the vehicle 12. Actual operations of the brake control part 100b will be described later.

The vehicle control ECU 100 is capable of acquiring data required for the idling stop control part 100a to carry out the idling stop control scheme and data required for the brake control part 100b to carry out the restart braking control scheme from the sensor 106 via an on-vehicle LAN or the like. The sensor 106 includes the vehicle speed sensor that detects the vehicle speed V, a MC pressure sensor (the pressure sensor 52) that detects the MC pressure, wheel cylinder pressure sensors that detect the wheel cylinder pressures of the wheel cylinders 38RL, 38RR, 38FL and 38FR, a negative pressure sensor that detects the negative pressure of the booster 32, a brake pedal sensor that detects whether the brake pedal 30 is depressed, an accelerator depression amount sensor that detects the depression amount of the accelerator pedal, and a battery sensor that detects the charging/discharging current, the terminal voltage, and the state of charge (“SOC”, i.e., the charged amount) of the battery 24.

The road gradient calculation part 100c calculates the gradient of the position of the road (the road gradient G) at which the vehicle 12 is present (i.e., the vehicle is traveling or has been stopped). The vehicle control ECU 100 can acquire data necessary to calculate the road gradient G from a sensor(s)/ECU (hereinafter, simply referred to as a “sensor”) 108 via the on-vehicle LAN, or the like. The sensor 108 includes a G sensor that detects acceleration (vehicle body acceleration) in the forward or backward direction of the vehicle, the vehicle speed sensor that detects the vehicle speed V, the ECU (the engine ECU 102) that calculates the output torque of the engine 14, and so forth. The vehicle body acceleration, the output torque of the engine 14, and the road gradient of the vehicle 12 have the mutual correlations. Therefore, the road gradient calculation part 100c can calculate the road gradient G based on a map, or the like, where the correlations between the vehicle body acceleration, the output torque of the engine 14, and the road gradient G are prescribed, by acquiring data from the G sensor and the engine ECU 102. The road gradient G can be calculated also in another method (for example, a method using road information previously stored in a navigation apparatus installed in the vehicle 12, or the like). The road gradient G has a positive value for an upslope, zero for a flat road, and a negative value for a downslope.

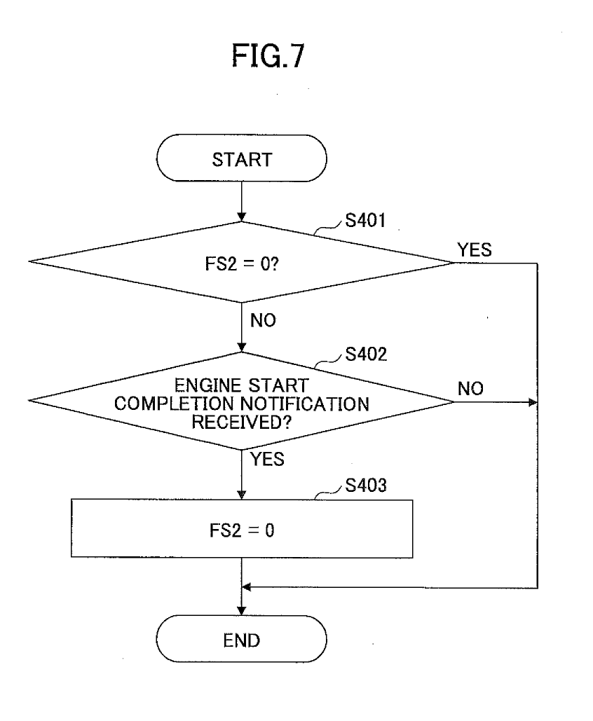

The upslope determination part 100d determines whether the vehicle 12 is present on an upslope. Actually, the upslope determination part 100d determines whether the vehicle 12 is present on an upslope, based on the road gradient G calculated by the road gradient calculation part 100c. Below, with reference to FIG. 8, a flow of a process carried out by the upslope determination part 100d will be described.

FIG. 8 is a flowchart conceptually illustrating one example of an upslope determination process carried out by the upslope determination part 100d. The upslope determination process of the flowchart is carried out when the engine 14 is automatically stopped according to the idling stop control scheme (i.e., when the engine stop flag FS1 becomes “1” from “0”).

“0” is set to an upslope flag FG that indicates whether the vehicle 12 is present on an upslope as an initial state when the vehicle 12 is started. Also, the upslope flag FG is returned to the initial state (FG=“0”) when the engine 14 is automatically started according to the idling stop control scheme (i.e., when the engine stop flag FS1 becomes “0” from “1”).

In step S501, the upslope determination part 100d acquires the road gradient G calculated by the road gradient calculation part 100c.

In step S502, the upslope determination part 100d determines whether the road gradient G is greater than zero and less than a predetermined threshold Gth. If this determination condition is satisfied (YES), the upslope, determination part 100d proceeds to step S503. If this determination condition is not satisfied (NO), the upslope determination part 100d proceeds to step S504.

In step S503, the upslope determination part 100d sets “1” to the upslope flag FG, and ends the current process.

In step S504, the upslope, determination part 100d sets “0” to the upslope flag FG, and ends the current process.

Returning to FIG. 3A, the determination part 100e determines various items concerning the above-described restart braking control scheme (i.e., the magnitude of the braking force to generate, the increasing rate of the braking force when the braking force is generated (i.e., the pressurization rate of the wheel cylinder pressures) and/or the like). Details will be described later.

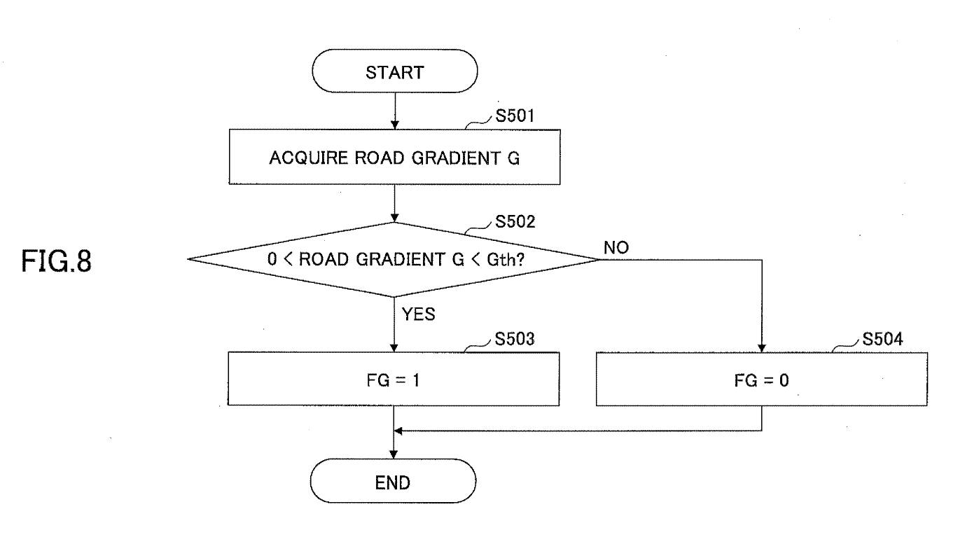

The engine ECU 102 controls operation states, for example, controls operations to start and stop the engine 14, and so forth. The engine ECU 102 carries out processes of stopping and starting the engine 14 in response to the engine stop request and the engine start request received from the vehicle control ECU 100 (the idling stop control part 100a). Below, with reference to FIG. 9, a flow of engine stopping and starting processes carried out by the engine ECU 102 will be described.

FIG. 9 is a flowchart conceptually illustrating one example of a control process carried out by the engine ECU 102. The flow is repetitiously carried out every predetermined period of time (for example, 50 ms) after the vehicle 12 is started until the vehicle 12 is stopped.

An engine state flag FEG indicates whether the engine is under rotation (FEG=“0”) or has been stopped (FEG=“1”).

In step S601, the engine ECU 102 determines whether the engine state flag FEG has “1”. If the engine state flag FEG does not have “1” (i.e., the engine state flag FEG has “0”), the engine ECU 102 proceeds to step S602. If the engine state flag FEG has “1”, the engine ECU 102 proceeds to step S606.

In step S602, the engine ECU 102 determines whether the engine ECU 102 receives the engine stop request from the vehicle control ECU 100 (the idling stop control part 100a). If the engine ECU 10 receives the engine stop request (YES), the engine ECU 10 proceeds to step S603. If the engine ECU 10 does not receive the engine stop request (NO), the engine ECU 10 ends the current process.

In step S603, the engine ECU 102 outputs a control command to the fuel injection value or the like of the engine 14 to stop the fuel supply at a predetermined timing, and thus, carries out a process of stopping the engine 14 (an engine stopping process).

In step S604, the engine ECU 102 outputs a notification indicating that the engine 14 is stopped through the engine stopping process in step S603 (the “engine stop completion notification”) to the vehicle control ECU 100.

In step S605, the engine ECU 102 sets “1” to the engine state flag FEG, and ends the current process.

In step S606, the engine ECU 102 determines whether the engine ECU 102 receives the engine start request from the vehicle control ECU 100 (the idling stop control part 100a). If the engine ECU 102 receives the engine start request (YES), the engine ECU 102 proceeds to step S607. If the engine ECU 102 does not receive the engine start request (NO), the engine ECU 102 ends the current process.

In step S607, the engine ECU 102 outputs a command to close a relay on a circuit to supply the power from the battery 24 to the starter 22 to start the starter 22, and outputs commands to the fuel injection valve, the ignition plug, and so forth, of the engine 14, to start the engine 14 (an engine starting process).

In step S608, after the starting of the engine 14 is completed through the starting process in step S607, the engine ECU 102 outputs a notification (the “engine start completion notification”) indicating that starting of the engine 14 is completed to the vehicle control ECU 100.

In step S609, the engine ECU 102 sets “0” to the engine state flag FEG, and ends the current process.

Returning to FIG. 3, the brake ECU 104 controls the operation states of the brake system 16. Actually, the brake ECU 104 outputs commands to the brake actuator 36 (i.e., the respective valves 48, 50, 54, 56, 58, 60, 74, 76, 78, and 80, and the pump 64 included therein) to control the operation states of the brake system 16, i.e., controls the wheel cylinder pressures of the respective wheel cylinders 38FR, 38FL, 38RR, and 38RL.

The brake ECU 104 normally outputs commands to the brake actuator such that the braking force according to the driver's operation (depression) amount will be applied to the respective wheels. In other words, the brake ECU 104 maintains the opened states of the regulating valves 48 and 50 of the brake actuator 36 so that the wheel cylinder pressures corresponding to the MC pressure will be output.

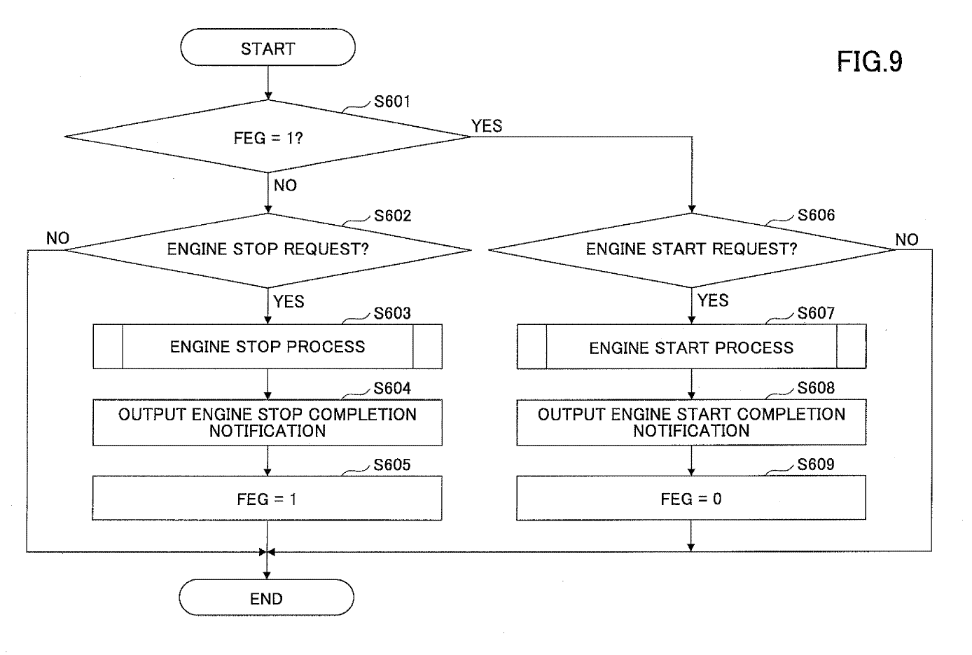

In response to receiving the brake pressurization request from the vehicle control ECU 100, the brake ECU 104 carries out a process (a brake pressurization process) to increase the wheel cylinder pressures to be greater than the MC pressure. Actually, as described above, by driving the pumps 64 and 84 while maintaining the closed states of the regulating valves 48 and 50, the brake ECU 104 increases the pressures in the accumulators 65 and 85 to generate the high wheel cylinder pressures. In response to receiving the brake pressurization stop request from the vehicle control ECU 100 during carrying out the brake pressurization process, the brake ECU 104 stops (ends) the brake pressurization process. Below, with reference to FIG. 10, a flow of the processes concerning starting and stopping the brake pressurization process carried out by the brake ECU 104 will be described.

FIG. 10 is a flowchart conceptually illustrating one example of the processes concerning starting and stopping the brake pressurization process carried out by the braking ECU 104. This flow is repetitiously carried out every predetermined period of time (for example, every 50 ms) after the vehicle 12 is started until the vehicle 12 is stopped.

A pressurization process flag FPP indicates whether the brake pressurization process is currently being carried out. Actually, the state of FPP=“0” indicates that the brake pressurization process is currently not being carried out. The state of FPP=“1” indicates that the brake pressurization process is currently being carried out.

In step S701, the brake ECU 104 determines whether the pressurization process flag FPP has “1”. If the FPP does not have “1” (i.e., the FPP has “0”), the brake ECU 104 proceeds to step S702. If the FPP has “1”, the brake ECU 104 proceeds to step S705.

In step S702, the brake ECU 104 determines whether the brake ECU 104 receives the brake pressurization request. If the brake ECU 104 receives the brake pressurization request, the brake ECU 104 proceeds to step S703. If the brake ECU 104 does not receive the brake pressurization request, the brake ECU 104 ends the current process.

In step S703, the brake ECU 104 starts the brake pressurization process.

Then, in step S704, the brake ECU 104 sets “1” to the pressurization process flag FPP, and ends the current process.

In step S705, the brake ECU 104 determines whether the brake ECU 104 receives the brake pressurization stop request from the vehicle control ECU 100. If the brake ECU 104 receives the brake pressurization stop request, the brake ECU 104 proceeds to step S706. If the brake ECU 104 does not receives the brake pressurization stop request, the brake ECU 104 ends the current process.

In step S706, the brake ECU 104 stops (ends) the brake pressurization process.

Then, in step S707, the brake ECU 104 sets “0” to the pressurization process flag FPP, and ends the current process.

The vehicle control ECU 100, the engine ECU 102, and the brake ECU 104 are implemented by, for example, a microcomputer(s) or the like, and, as a result of the CPU(s) executing various programs stored in the ROM(s), the above-described various control processes can be implemented. However, as long as the vehicle control ECU 100, the engine ECU 102, and the brake ECU 104 can carry out the above-described various control processes, they can be implemented by any hardware, software, firmware, or any combinations thereof.

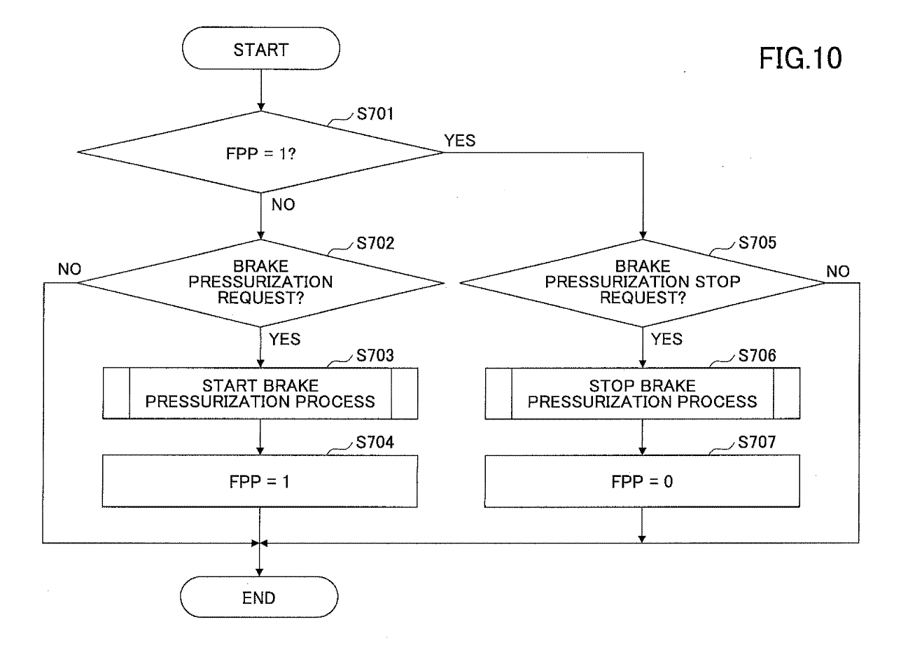

With reference to FIG. 11, the restart braking control scheme carried out by the vehicle control apparatus 10 (the brake control part 100b) according to an embodiment will be described in detail.

FIG. 11 is a flowchart conceptually illustrating one example of the restart braking control scheme carried out by the vehicle control apparatus 10 (the brake control part 100b). This flow is repetitiously carried out every predetermined period of time (for example, every 50 ms) after the vehicle 12 is started until the vehicle 12 is stopped.

A pressurization request flag FP indicates whether the brake pressurization process by the brake ECU 104 is currently being carried out as a result of the brake pressurization request being output. “0” is set to the pressurization request flag FP as an initial state when the vehicle 12 is started.

In step S801, the brake control part 100b determines whether the pressurization request flag FP has “1”. If the pressurization request flag FP does not have “1” (i.e., the pressurization request flag FP has “0”), the brake control part 100b proceeds to step S802. If the pressurization request flag FP has “1”, the brake control part 100b proceeds to step S809.

In step S802, the brake control part 100b determines whether the engine start flag FS2 has “2”, i.e., whether the engine 14 is currently being started due to satisfaction of the engine start condition for the idling stop control scheme as a result of the predetermined braking stopping operation being performed. If the engine start flag FS2 has “2”, the brake control part 100b proceeds to step S803. If the engine start flag FS2 does not have “2” (i.e., the engine start flag FS2 has “1” or “0”), the brake control part 100b ends the current process.

In step S803, the brake control part 100b determines whether the upslope flag FG has “1”, i.e., whether the vehicle 12 is on an upslope. If the upslope flag FG has “1”, the brake control part 100b proceeds to step S804. If the upslope flag FG does not have “1” (i.e., the upslope flag FG has “0”), the brake control part 100b ends the current process.

In step S804, the brake control part 100b determines whether the vehicle 12 is in a stopped state (which can be a state of traveling backward), i.e., whether the vehicle speed V is less than or equal to the predetermined threshold Vth0. If the vehicle speed V is greater than the predetermined threshold Vth0, i.e., if the vehicle has not been stopped yet, the brake control part 100b proceeds to step S805. If the vehicle speed V is less than or equal to the predetermined threshold Vth0, i.e., the vehicle is in a stopped state (or in a state of traveling backward), the brake control part 100b proceeds to step S806.

In step S805, the brake control part 100b determines whether the vehicle speed V is less than or equal to a predetermined threshold (a second speed) Vth2 that is less than the predetermined threshold Vth1. If the vehicle speed V is less than or equal to the predetermined threshold Vth2, the brake control part 100b proceeds to step S807. If the vehicle speed V is greater than the predetermined threshold Vth2, the brake control part 100b ends the current process.

Step S805 can be omitted. That is, if the determination condition in step S804 is satisfied (YES in step S804), the brake control part 100b can directly proceed to step S807.

In step S806, the brake control part 100b determines whether the wheel cylinder pressures PWC are less than the predetermined threshold PSth. If the wheel cylinder pressures PWC are less than the predetermined threshold PSth, the brake control part 100b proceeds to step S807. If the wheel cylinder pressures PWC are greater than or equal to the predetermined threshold PSth, the brake control part 100 ends the current process.

The predetermined threshold PSth is the wheel cylinder pressure corresponding to the braking force required to maintain a stopped state of the vehicle 12 on an upslope, and is predetermined through an experiment, a simulation, or the like.

In step S807, the brake control part 100b outputs the brake pressurization request to the brake ECU 104.

Then, in step S808, the brake control part 100b sets “1” to the pressurization request flag FP, and ends the current process.

In step S809, the brake control part 100b determines whether the engine start flag FS2 has “0”, i.e., whether starting of the engine 14 is completed. If the engine start flag FS2 has “0”, the brake control part 100b proceeds to step S810. If the engine start flag FS2 does not have “0” (i.e., the engine start flag FS2 has “2”), the brake control part 100b ends the current process.

In step S810, the brake control part 100b outputs the brake pressurization stop request to the brake ECU 104.

Then, in step S811, the brake control part 100b sets “0” to the pressurization request flag, and ends the current process.

If the brake control part 100b is configured to not carry out the deceleration idling stop control scheme (i.e., the brake control part 100b is configured to only carry out the stopping idling stop control scheme), the flowchart shown in FIG. 11 is changed to be such that steps S804 and S805 are omitted, and, if the determination result of step S803 is YES, the brake control part 100b proceeds to step S806.

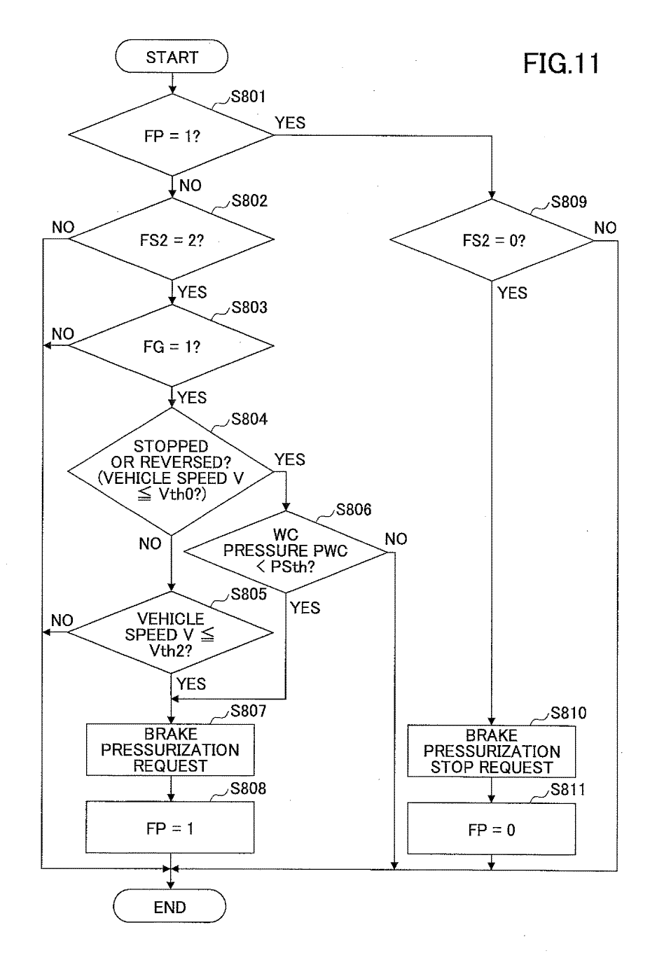

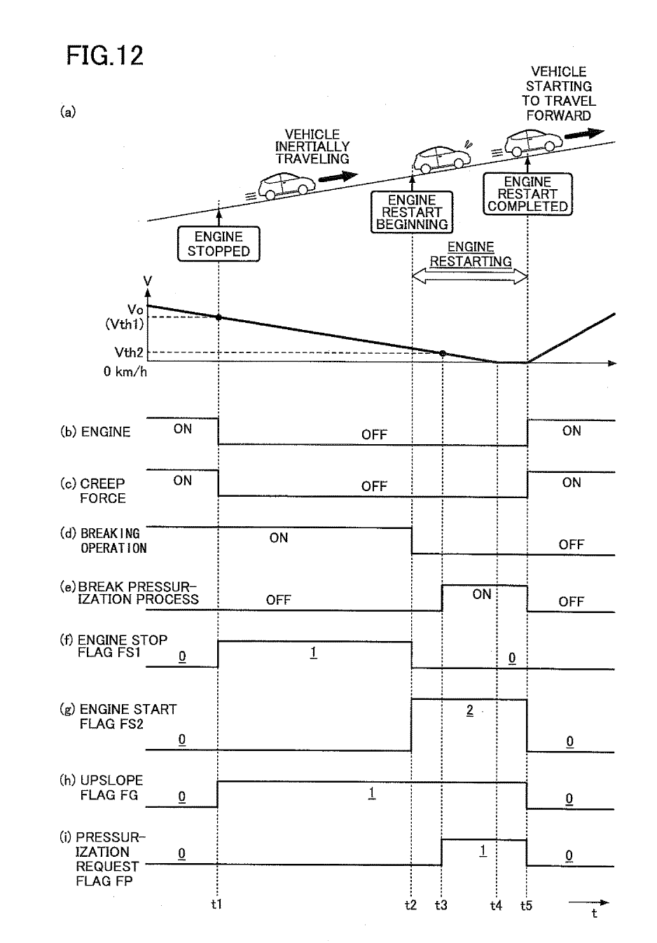

With reference to actual examples shown in FIGS. 12 and 13, operation timings of the vehicle control apparatus 10 (the brake control part 100b) according to the present embodiment will be described.

FIG. 12 is a timing chart illustrating one example of operations of the vehicle control apparatus 10 according to the present embodiment. FIG. 12 illustrates, concerning the vehicle 12 on an upslope, respective temporal changes in (a) the vehicle speed V, (b) an operation state of the engine 14, (c) whether a creep torque is generated, (d) whether a braking operation is performed, (e) whether the brake pressurization process is carried out, (f) the engine stop flag FS1, (g) the engine start flag FS2, (h) the upslope flag FG, and (i) the pressurization request flag FP.

In FIG. 12, it is assumed that the gradient of the upslope where the vehicle 12 is, i.e., the road gradient G, is greater than 0 and less than the predetermined threshold Gth.

At a time t1, as a result of the vehicle speed V becoming less than the starting vehicle speed V0 (the predetermined threshold Vth1) in a deceleration state (i.e., in a state where the driver performs the predetermined braking operation) of the vehicle 12, the engine stop condition for the deceleration idling stop control scheme is satisfied (see items (a) and (d) in FIG. 12). Therefore, the idling stop control part 100a outputs the engine stop request to the engine ECU 102, and automatically stops the engine 14 (see items (b) and (f) of FIG. 12). Note that no creep torque is generated until restarting of the engine 14 is completed (i.e., until time t5) after the time t1 (see items (b) and (c) of FIG. 12).

During a period of time from the time t1 to a time t2, the driver of the vehicle 12 continues the braking operation, and the vehicle 12 travels inertially while decelerating (see items (a) and (d) of FIG. 12).

At time the t2 at which the vehicle 12 has not been stopped yet, a braking stopping operation (i.e., to stop the braking) is performed. Thereby, the engine start condition for the idling stop control scheme is satisfied (see items (a) and (d) of FIG. 12). Therefore, the idling stop control part 100a outputs the engine start request to the engine ECU 102, and thus, restarting of the engine 14 begins (see items (f) and (g) of FIG. 12).

During a period of time from the time t2 to the time t3 during which the engine 14 is being restarted, the conditions of steps S802 and S803 in FIG. 11 are satisfied. However, because the vehicle speed V is still greater than the predetermined threshold Vth2, the condition of step S805 is not satisfied (see items (a), (g) and (h) of FIG. 12). Therefore, the brake control part 100b does not start the brake pressurization process (see items (e) and (i) of FIG. 12).

At a time t3, the vehicle speed V reaches the predetermined threshold Vth2, and thus, the condition of step S805 in FIG. 11 is satisfied. Therefore, the brake control part 100b outputs the brake pressurization request to the brake ECU 104, and starts the brake pressurization process (see items (e) and (i) of FIG. 12). Thus, the braking force is automatically applied to the vehicle 12 under the condition after the braking stopping operation is carried out.

Thereafter, during a period of time from the time t3 to a time t4 during which the engine 14 is being restarted, the vehicle 12 further decelerates due to the braking force generated by the brake pressurization process and the gravitational acceleration, and the vehicle speed V becomes 0 at time the t4 (see items (a), (e), and (i) of FIG. 12).

Therefore, during a period of time from the time t4 to a time t5 during which the engine 14 is being restarted after the traveling speed of the vehicle 12 becomes 0, no creep torque is generated as described above (see items (a) and (c) of FIG. 12). However, because the brake pressurization process is being carried out, it is possible to maintain the stopped state of the vehicle 12 by thus generating a relatively great braking force. In other words, it is possible to prevent the vehicle 12 from crawling down (see items (e) and (i) of FIG. 12).

When the restarting of the engine 14 is completed at the time t5, the engine start flag FS2 comes to have “0”. Thereby, the condition of step S807 in FIG. 11 is satisfied (see items (b) and (g) of FIG. 12). Therefore, the brake control part 100b outputs the brake pressurization stop request to the brake ECU 104, and ends the brake pressurization process (see items (e) and (i) of FIG. 12).

After the time t5, also a creep torque is generated as a result of the engine 14 having been restarted. Therefore, the vehicle 12 is capable of restarting to travel forward from the stopped state (see items (a) through (c) of FIG. 12).

Thus, according to the present embodiment, as a result of the brake pressurization process being carried out, it is possible to prevent the vehicle 12 from crawling down, for a case where the engine start condition is satisfied before the vehicle is stopped and the engine 14 is to be restarted as a result of a predetermined braking stopping operation being carried out.

In more detail, restarting of the engine 14 begins if the engine start condition is satisfied as a result of a braking stopping operation being performed before the vehicle 12 is stopped after the engine 14 is stopped during traveling (i.e., during deceleration of the vehicle 12) according to the deceleration idling stop control scheme. At this time, if the vehicle 12 is on an upslope, the vehicle 12 may crawl down depending on the vehicle speed if no depression operation is performed on the brake pedal 30 or the depression amount on the brake pedal 30 is very small because no creep torque is generated in the vehicle until the starting of the engine 14 is completed. According to the present embodiment, during a period of time from when the engine start condition is satisfied as a result of a braking stopping operation being performed until restarting of the engine 14 is completed, it is possible to carry out a brake pressurization process for applying relatively great braking force to the vehicle 12 automatically due to high oil pressure supplied by the pumps 64 and 84 and the accumulators 65 and 85 if it is determined that the vehicle 12 is on an upslope. Thereby, it is possible to prevent the vehicle 12 from crawling down, which may otherwise occur in such a situation.

Also, according to the present embodiment, during a period of time from when the engine start condition is satisfied as a result of a braking stopping operation being performed until the starting of the engine 14 is completed, if it is determined that the vehicle 12 is on an upslope and the vehicle speed V is less than or equal to the predetermined threshold Vth2, the brake pressurization process is carried out. Thereby, a braking force is automatically applied to the vehicle 12 at a time a likelihood of crawling down of the vehicle 12 increases (i.e., at a time the vehicle speed V becomes less than or equal to the predetermined threshold Vth2). Therefore, it is possible to not only avoid the driver's feeling that something is wrong due to a braking force being automatically applied but also avoid crawl down of the vehicle.

In a case where the vehicle 12 is on a downslope, it can be estimated that the driver indicates an intention to cause the vehicle 12 to travel forward, i.e., cause the vehicle 12 to move in the descending direction, if the driver performs a braking stopping operation. Therefore, a likelihood that a problem occurs is very small, even if the vehicle 12 moves in the descending direction in a case where the engine start condition is satisfied as a result of the braking stopping operation being performed after the engine 14 is automatically stopped and the engine 14 is to be restarted.

The braking force to be applied to the vehicle 12 through the brake pressurization process can be made greater than a braking force (which can be determined through an experiment or a simulation) that is applied to the vehicle 12 immediately before the engine start condition is satisfied as a result of a braking stopping operation being performed. That is, the braking force to be applied to the vehicle 12 through the brake pressurization process can be made greater than the braking force corresponding to the MC pressure applied immediately before the engine start condition is satisfied as a result of a braking stopping operation being performed. As a result, it is possible to avoid crawling down of the vehicle 12 even if a braking force greater than a braking force corresponding to a braking operation amount applied immediately before the engine start condition is satisfied is required for maintaining the vehicle's stopped state. That is, without regard to an actual depression operation on the brake pedal 30 performed by the driver, it is possible to avoid crawling down of the vehicle 12.

FIG. 13 is a timing chart illustrating another example of operations of the vehicle control apparatus 10 according to the present embodiment. In the same manner as FIG. 12, FIG. 13 shows, concerning the vehicle 12 on an upslope, respective temporal changes in (a) the vehicle speed V, (b) an operation state of the engine 14, (c) whether a creep torque is generated, (d) whether a braking operation is performed, (e) whether the brake pressurization process is carried out, (f) the engine stop flag FS1, (g) the engine start flag FS2, (h) the upslope flag FG, and (i) the pressurization request flag FP.

In the operation example of FIG. 13, in the same way as FIG. 12, it is assumed that the gradient of the upslope where the vehicle 12 is, i.e., the road gradient G, is greater than 0 and less than the predetermined threshold Gth. Also, in the operation example of FIG. 13, it is assumed that the engine 14 is automatically stopped according to the stopping idling stop control scheme.

Before a time t1, the driver performs a braking operation, and the vehicle 12 is in a deceleration state (see FIG. 13, (a) and (d)).

At the time t1, as a result of the vehicle 12 having been stopped, the engine stop condition for the stopping idling stop control scheme is satisfied (see FIG. 13 (a) and (d)). Therefore, the idling stop control part 100a outputs the engine stop request to the engine ECU 102, and automatically stops the engine 14 (FIG. 13 (b) and (f)). Until restarting of the engine 14 is completed (until a time t3 described later) after the time t1, no creep torque is generated (see FIG. 13 (b) and (c)).

Immediately after the engine has stopped (immediately after the time t1), at a time t2, as a result of the driver performing a braking stopping operation, the engine start condition according to the idling stop control scheme is satisfied (see FIG. 13 (a) and (d)). Therefore, the idling stop control part 100a outputs the engine start request to the engine ECU 102, and restarting of the engine 14 begins (see FIG. 13 (f) and (g)).

Because the braking stopping operation is performed immediately after the engine has been stopped, i.e., immediately after the vehicle 12 has been stopped, the stopped state is not completely maintained also immediately before the braking stopping operation is performed. Therefore, even if a braking force of the vehicle 12 is maintained as a result of the regulating valves 48 and 50 being closed as described above (i.e., even if a so-called hill-hold function is used), the braking force applied to the vehicle 12 immediately before the engine start condition is satisfied does not reach such an amount as to be able to maintain the stopped state of the vehicle 12. That is, the wheel cylinder pressures PWC are less than the predetermined threshold PSth. If the vehicle 12 does not have the hill-hold function, the wheel cylinder pressures PWC applied immediately before the engine start condition is satisfied due to a predetermined braking stopping operation being performed are less than the predetermined threshold PSth accordingly. That is, at the time t2, the conditions of steps S802, S803, and S806 are satisfied (see FIG. 13 (a), (g), and (i)). Therefore, the brake control part 100b outputs the brake pressurization request to the brake ECU 104, and starts the brake pressurization process (see FIG. 13, (e) and (i)). Thus, in a state after the braking stopping operation is performed, the braking force is automatically applied to the vehicle 12.

During the period of time from the time t2 to a time t3 during which the engine 14 is being restarted, no creep torque is generated as described above (see FIG. 13, (a) and (c)). However, as a result of the brake pressurization process being carried out, it is possible to maintain the stopped state of the vehicle 12 by generating a relatively great braking force in the vehicle 12. That is, it is possible to avoid crawling down of the vehicle 12 (see FIG. 13, (e) and (i)).

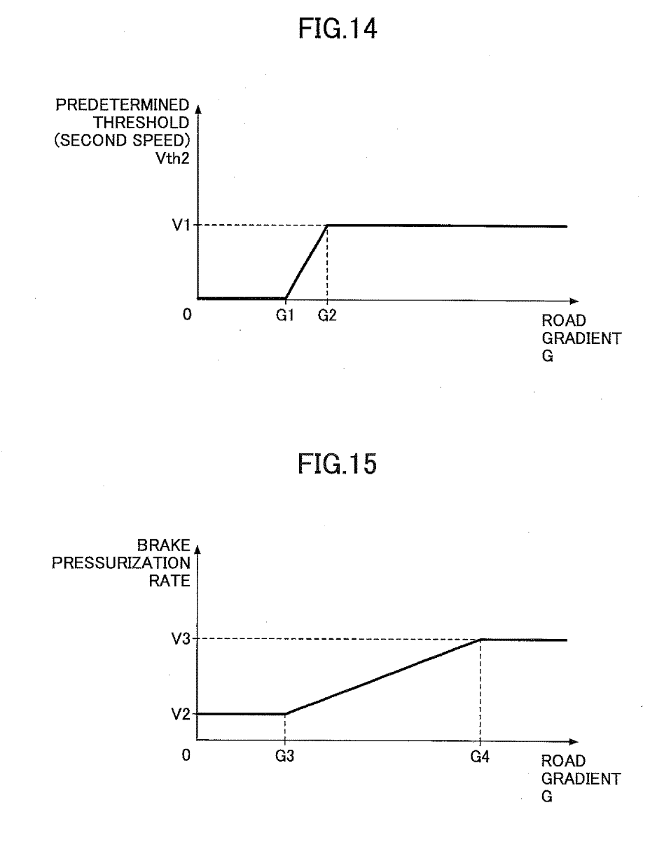

After the restarting of the engine 14 is completed at the time t3, the engine start flag FS2 becomes “0”. As a result, the condition of step S809 of FIG. 15 is satisfied (see FIG. 13, (b) and (g)). Thus, the brake control part 100b outputs the brake pressurization stop request to the brake ECU 104, and ends the brake pressurization process (see FIG. 13, (e) and (i)).

After the time t3, also a creep torque is generated as a result of the engine 14 being restarted. Thus, the vehicle 12 can again start traveling forward from the stopped state (see FIG. 13, (a) through (c)).

In FIGS. 11 through 13, the brake pressurization process is ended when restarting of the engine 14 has been completed. However, the timing of ending the brake pressurization process can be a timing also after restarting of the engine 14 is completed. That is, the brake pressurization process ending timing can be any timing at the same time when or after restarting of the engine 14 is completed.

Thus, according to the present embodiment, by carrying out the brake pressurization process, it is possible to avoid crawling down of the vehicle 12 that may otherwise occur when the engine 14 is to be restarted due to satisfaction of the engine start condition in a stopped state as a result of a predetermined braking stopping operation being performed.

In more detail, restarting of the engine 14 begins due to satisfaction of the engine start condition as a result of a braking stopping operation being performed immediately after the engine 14 is stopped through the stopping idling stop control scheme. In this situation, there may be a case where the braking stopping operation is performed from a state where the stopped state of the vehicle 12 is not completely maintained, i.e., the braking force corresponding to the driver's braking operation amount is not sufficient. In this regard, no creep torque is applied to the vehicle 12 until the starting of the engine 14 is completed. Therefore, if no depression operation is performed on the brake pedal 30 or the depression amount on the brake pedal 30 is very small, the vehicle 12 may crawl down when the vehicle 12 is on an upslope, even if the braking force corresponding to the braking operation amount is maintained due to a so-called hill-hold function or the like. Such a problem may occur also if the engine 14 is restarted due to a braking stopping operation being performed immediately after the vehicle 12 is stopped in a state where the engine 14 has been stopped through the deceleration idling stop control scheme. According to the present embodiment, it is possible to carry out a brake pressurization process through which a relatively great braking force can be automatically generated with a high brake oil pressure supplied by the pumps 64 and 84 and the accumulators 65 and 85, if (i) the engine start condition is satisfied as a result of a braking stopping operation being performed in a state where the vehicle 12 has been stopped, (ii) it is determined that the vehicle 12 is on an upslope, and (iii) the wheel cylinder pressures PWC corresponding to the braking force applied to the vehicle are less than the predetermined threshold PSth. Thereby, it is possible to avoid crawling down of the vehicle 12 in such a case.

In FIGS. 11 through 13, the brake pressurization process is ended when restarting of the engine 14 has been completed. However, the timing of ending the brake pressurization process can be a timing also after restarting of the engine 14 is completed. That is, the brake pressurization process ending timing can be any timing at the same time when or after restarting of the engine 14 is completed.

How to determine various factors in the restart braking control scheme (the brake pressurization process by the brake ECU 104) carried out by the brake control part 100b will now be described.

The determination part 100e can change, depending on the road gradient G of the upslope, the braking force (corresponding to the wheel cylinder pressures) to be applied to the vehicle 12 in the brake pressurization process. In more detail, the greater the gradient of the upslope becomes, the greater the downward component of the gravity applied to the vehicle 12 on the upslope becomes, and thus, the greater the likelihood of crawling down becomes. Therefore, the determination part 100e determines the braking force to be applied to the vehicle 12 in the brake pressurization process in such a manner that, the greater the road gradient G of the upslope calculated by the road gradient calculation part 100c becomes, the greater the braking force becomes. Thereby, even when the gravity component applied to the vehicle 12 changes depending on the gradient of the upslope, it is possible to automatically generate the braking force of the vehicle 12 required for maintaining the stopped state against the gravity component. Thus, it is possible to positively prevent the vehicle 12 on an upslope from crawling down.

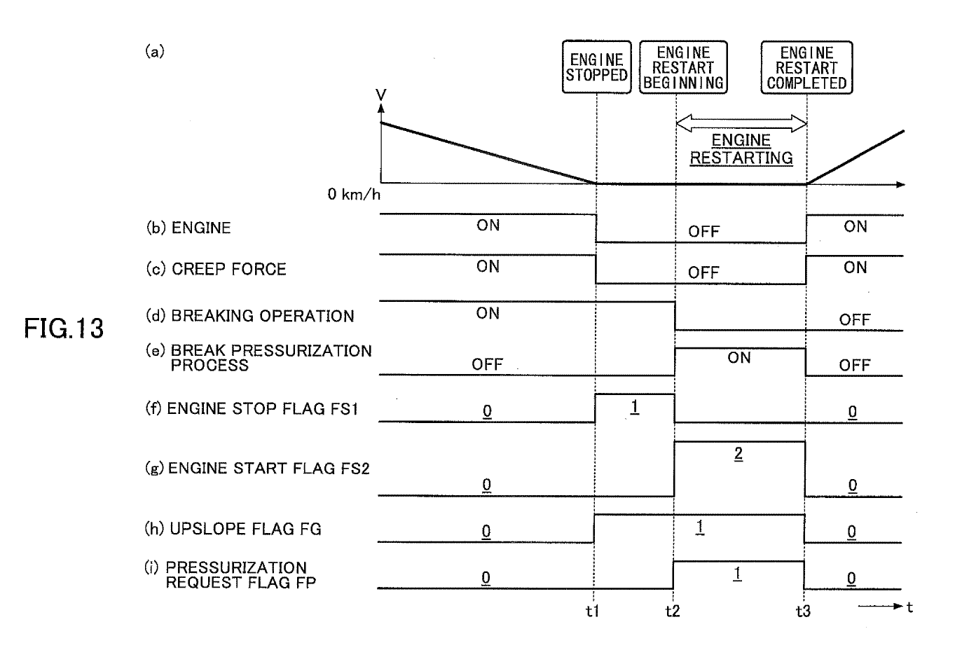

Also, the determination part 100e can change the timing at which the brake pressurization process is started after the engine start condition is satisfied as a result of a braking stopping operation being performed, depending on the road gradient G of the upslope where the vehicle 12 is. In more detail, the timing is set in such a manner that, the greater the road gradient G becomes, the earlier the timing becomes. That is, the determination part 100e sets the predetermined threshold Vth2 corresponding to this timing in such a manner that, the greater the road gradient G of the upslope calculated by the road gradient calculation part 100c becomes, the greater the predetermined threshold Vth2 becomes. For example, the predetermined threshold Vth2 is determined, as shown in FIG. 14 (one example of a map illustrating relationships between the road gradient of the upslope and the vehicle speed (the predetermined threshold Vth2) at which the brake pressurization process is started), in the manner of following items (i), (ii) and (iii). That is, (i) the predetermined threshold Vth2 is set to be zero when the road gradient G of the upslope is in a range from zero through a first angle G1. (ii) The predetermined threshold Vth2 is set such that, the greater the road gradient G becomes, the greater the predetermined threshold Vth2 becomes linearly, when the road gradient G is in a range from the first angle G1 through a second angle G2. (iii) The predetermined threshold Vth2 is set to be a relatively great constant value (a predetermined value V1), when the road gradient G is greater than or equal to the second angle G2. That is, the greater the gradient of the upslope becomes, the earlier the timing becomes at which the vehicle 12 crawls down on the upslope after the braking stopping operation due to the gravity force. However, according to the above-described configuration, even when the gravity component applied to the vehicle 12 varies depending on the gradient of the upslope, it is possible to automatically generate the braking force of the vehicle 12 at the timing depending on the gravity component. Thus, it is possible to positively prevent the vehicle 12 from crawling down on the upslope.

Also, the determination part 100e can change the pressurization rate (i.e., the change rate of the braking force) from when the automatic generation of the braking force is started until the braking force reaches the desired braking force using the pumps 64 and 84, and so forth, in the brake pressurization process, depending on the road gradient G of the upslope. Actually, the pressurization rate is determined in such a manner that, the greater the road gradient G of the upslope calculated by the road gradient calculation part 100c becomes, the greater the pressurization rate becomes. For example, the pressurization rate is determined, as shown in FIG. 15 (one example of a map illustrating relationships between the road gradient G of the upslope and the brake pressurization rate), in the manner of following items (1), (ii) and (iii). That is, (i) when the road gradient G is in a range from zero through a third angle G3, the pressurization rate is determined to have a relatively small constant value (a predetermined value V2). (ii) When the road gradient G is in a range from the third angle G3 through a fourth angle G4, the pressurization rate is set such that, the greater the road gradient G becomes, the greater the pressurization rate becomes linearly. (iii) When the road gradient G is greater than or equal to the fourth angle G4, the pressurization rate is determined to be a relatively great constant value (a predetermined value V3). In this configuration, even if the amount of the gravity component applied to the vehicle 12 varies according to the gradient of the upslope, it is possible to increase the braking force to be applied to the vehicle 12 up to the desired braking force at the pressurization rate depending on the gravity component. Thus, it is possible to positively prevent the vehicle 12 from crawling down on the upslope.

According to the embodiments, it is possible to provide a vehicle control apparatus capable of preventing crawling down of a vehicle on an upslope if an engine is to be restarted as a result of a braking stopping operation being performed before the vehicle is stopped after an engine is automatically stopped according to an idling stop control scheme.

Thus, the vehicle speed control apparatuses have been described in the embodiments. However, the present disclosure is not limited to these embodiments. Various modifications and/or improvements such as combinations with part or all of another embodiment(s), a replacement(s) with part of another embodiment(s), and so forth, can be made.

What is claimed is:

1. A vehicle control apparatus comprising:
at least one processor configured to
automatically stop an engine that is a drive power source of a vehicle if a predetermined engine stop condition, including a condition that a predetermined braking operation is performed and a condition that a vehicle speed that is detected becomes less than or equal to a predetermined first speed is satisfied, and automatically start the engine if a predetermined engine start condition is satisfied, including a condition that, after the engine is automatically stopped, a predetermined braking stopping operation is performed,
determine whether the vehicle is on an upslope, and
cause the vehicle to automatically generate a braking force if the at least one processor determines that the vehicle is on the upslope, during a period of time from when the engine start condition is satisfied until the starting of the engine is completed, the engine start condition being satisfied as a result of the predetermined braking stopping operation being performed before the vehicle is stopped after the engine is automatically stopped.

2. The vehicle control apparatus as claimed in claim 1, wherein
the at least one processor is configured to cause the vehicle to automatically generate the braking force if, during the period of time, the at least one processor determines that the vehicle is on the upslope, and the vehicle speed is less than or equal to a second speed less than the first speed.

3. The vehicle control apparatus as claimed in claim 1, wherein
the at least one processor is configured to cause the vehicle to automatically generate the braking force in the vehicle if (i) the engine start condition is satisfied as a result of the predetermined braking stopping operation being performed in a state where the vehicle has been stopped after the engine is automatically stopped, (ii) the at least one processor determines that the vehicle is on the upslope, and (iii) the braking force applied to the vehicle is less than or equal to a predetermined threshold.

4. The vehicle control apparatus as claimed in claim 2, wherein
the at least one processor is configured to cause the vehicle to automatically generate the braking force in the vehicle if (i) the engine start condition is satisfied as a result of the predetermined braking stopping operation being performed in a state where the vehicle has been stopped after the engine is automatically stopped, (ii) the at least one processor determines that the vehicle is on the upslope, and (iii) the braking force applied to the vehicle is less than or equal to a predetermined threshold.

5. The vehicle control apparatus as claimed in claim 1, wherein
the braking force that the at least one processor causes the vehicle to automatically generate is greater than a braking force corresponding to a braking operation amount applied immediately before the engine start condition is satisfied as a result of the predetermined braking stopping operation being performed.

6. The vehicle control apparatus as claimed in claim 2, wherein
the braking force that the at least one processor causes the vehicle to automatically generate is greater than a braking force corresponding to a braking operation amount applied immediately before the engine start condition is satisfied as a result of the predetermined braking stopping operation being performed.

7. The vehicle control apparatus as claimed in claim 3, wherein
the braking force that the at least one processor causes the vehicle to automatically generate is greater than a braking force corresponding to a braking operation amount applied immediately before the engine start condition is satisfied as a result of the predetermined braking stopping operation being performed.

8. The vehicle control apparatus as claimed in claim 4, wherein
the braking force that the at least one processor causes the vehicle to automatically generate is greater than a braking force corresponding to a braking operation amount applied immediately before the engine start condition is satisfied as a result of the predetermined braking stopping operation being performed.

9. The vehicle control apparatus as claimed in claim 1, wherein
the at least one processor is further configured to
calculate a road gradient of a road where the vehicle is, and
determine the braking force that the at least one processor causes the vehicle to automatically generate such that, the greater the road gradient of the upslope becomes, the greater the braking force becomes.

10. The vehicle control apparatus as claimed in claim 2, wherein
the at least one processor is further configured to
calculate a road gradient of a road where the vehicle is, and
determine the braking force that the at least one processor causes the vehicle to automatically generate such that, the greater the road gradient of the upslope becomes, the greater the braking force becomes.

11. The vehicle control apparatus as claimed in claim 3, wherein
the at least one processor is further configured to
calculate a road gradient of a road where the vehicle is, and
determine the braking force that the at least one processor causes the vehicle to automatically generate such that, the greater the road gradient of the upslope becomes, the greater the braking force becomes.

12. The vehicle control apparatus as claimed in claim 4, wherein
the at least one processor is further configured to
calculate a road gradient of a road where the vehicle is, and
determine the braking force that the at least one processor causes the vehicle to automatically generate such that, the greater the road gradient of the upslope becomes, the greater the braking force becomes.

13. The vehicle control apparatus as claimed in claim 5, wherein
the at least one processor is further configured to
calculate a road gradient of a road where the vehicle is, and
determine the braking force that the at least one processor causes the vehicle to automatically generate such that, the greater the road gradient of the upslope becomes, the greater the braking force becomes.

14. The vehicle control apparatus as claimed in claim 6, wherein
the at least one processor is further configured to
calculate a road gradient of a road where the vehicle is, and
determine the braking force that the at least one processor causes the vehicle to automatically generate such that, the greater the road gradient of the upslope becomes, the greater the braking force becomes.

15. The vehicle control apparatus as claimed in claim 7, wherein
the at least one processor is further configured to
calculate a road gradient of a road where the vehicle is, and
determine the braking force that the at least one processor causes the vehicle to automatically generate such that, the greater the road gradient of the upslope becomes, the greater the braking force becomes.

16. The vehicle control apparatus as claimed in claim 8, wherein
the at least one processor is further configured to
calculate a road gradient of a road where the vehicle is, and
determine the braking force that the at least one processor causes the vehicle to automatically generate such that, the greater the road gradient of the upslope becomes, the greater the braking force becomes.

17. The vehicle control apparatus as claimed in claim 2, wherein
the at least one processor is configured to
calculate a road gradient of a road where the vehicle is, and
determine the second speed such that, the greater the road gradient of the upslope becomes, the greater the second speed becomes.

18. The vehicle control apparatus as claimed in claim 1, wherein
the at least one processor is configured to
calculate a road gradient of a road where the vehicle is, and
determine an increasing rate at which the braking force increases when the brake control part causes the vehicle to automatically generate the braking force such that, the greater the road gradient of the upslope becomes, the greater the increasing rate becomes.

19. The vehicle control apparatus as claimed in claim 2, wherein
the at least one processor is configured to
calculate a road gradient of a road where the vehicle is, and
determine an increasing rate at which the braking force increases when the brake control part causes the vehicle to automatically generate the braking force such that, the greater the road gradient of the upslope becomes, the greater the increasing rate becomes.

20. The vehicle control apparatus as claimed in claim 3, wherein
the at least one processor is configured to
calculate a road gradient of a road where the vehicle is, and
determine an increasing rate at which the braking force increases when the brake control part causes the vehicle to automatically generate the braking force such that, the greater the road gradient of the upslope becomes, the greater the increasing rate becomes.
